(19) United States
(12) Patent Application Publication
(10) Pub. No.: US 2019/0103074 A1
(43) Pub. Date: Apr. 4, 2019

(54) TECHNOLOGIES FOR SECURE Z-ORDER ENFORCEMENT WITH TRUSTED DISPLAY

(71) Applicant: Intel Corporation, Santa Clara, CA (US)

(72) Inventors: Siddhartha Chhabra, Portland, OR (US); Prashant Dewan, Portland, OR (US)

(21) Appl. No.: 15/720,090

(22) Filed: Sep. 29, 2017

(51) Int. Cl. G09G 5/377; H04L 9/08; G09G 5/00

(52) U.S. Cl. CPC G09G 5/377; H04L 9/088; G09G 2358/00; G09G 2354/00; G09G 2340/12; G09G 5/006

(57) ABSTRACT

Technologies for secure z-order enforcement include a computing device having a processor with secure enclave support. A secure enclave invokes an EBIND instruction with display programming information that includes a z-order enforcement policy indicating whether the secure enclave requests z-order enforcement for an overlay surface associated with the secure enclave. The processor generates wrapped programming information in response to invoking the EBIND instruction. An untrusted supervisor component such as a device driver invokes an UNWRAP instruction with the wrapped programming information. The processor unwraps the wrapped programming information and programs a display controller with the z-enforcement policy. The processor may read a z-order enforcement status register of the display controller to determine if an overlay surface is available. For z-order enforcement, the display controller composes the overlay surface associated with the secure enclave in front of all other overlay surfaces of the display controller. Other embodiments are described and claimed.

### BACKGROUND

Typical computing devices may rely on software agents, such as anti-malware agents, for security. However, it is difficult to keep up with the increasing number of malware attacks on users' devices. To combat the malware threat, there is a trend to protect security sensitive software by running it inside a Trusted Execution Environment (TEE). TEEs provide a sterile environment that can protect secrets even when other parts of the system are compromised. Examples of TEEs include Intel® Software Guard Extensions (Intel® SGX), secure virtual machines (VMs), and a converged security engine (CSE). The TEE, while useful to protect secrets within the TEE, may not protect I/O data such as graphics data that is communicated into and/or out of the secure “container.” The security requirements for trusted I/O vary per use case and device, and involve flavors and combinations of confidentiality, integrity, liveliness, and replay protection.

U.S. Pat. No. 9,501,668, entitled Secure Video Output Path, describes techniques for secure delivery of output surface bitmaps to a display engine. As described in that patent, an application executing in a secure enclave may generate an output surface bitmap encrypted with a surface encryption key, and a display engine may use the surface encryption key to decrypt the surface bitmap to be rendered on display.

Typical graphical workstations or other computing devices with graphical user interfaces may display graphics data from multiple applications simultaneously on the same display. Certain devices may perform hardware compositing to combine multiple images into a single output image. During the compositing process, the computing device may render graphics data from one application “in front of,” “on top of,” or otherwise obscuring graphics data from another application.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for secure z-order enforcement;

FIG. 2 is a simplified block diagram of at least one embodiment of an environment that may be established by the computing device of FIG. 1

FIG. 3 is a simplified flow diagram of at least one embodiment of a method for trusted display with z-order enforcement that may be executed by the computing device of FIGS. 1-2;

FIG. 4 is a simplified flow diagram of at least one embodiment of a method for display controller device management that may be executed by the computing device of FIGS. 1-2;

FIG. 5 is a simplified flow diagram of at least one embodiment of a method for display programming information wrapping that may be executed by the computing device of FIGS. 1-2;

FIG. 6 is a simplified flow diagram of at least one embodiment of a method for display programming information unwrapping and display controller programming that may be executed by the computing device of FIGS. 1-2; and

FIG. 7 is a simplified flow diagram of at least one embodiment of a method for display compositing with z-order enforcement that may be executed by the computing device of FIGS. 1-2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

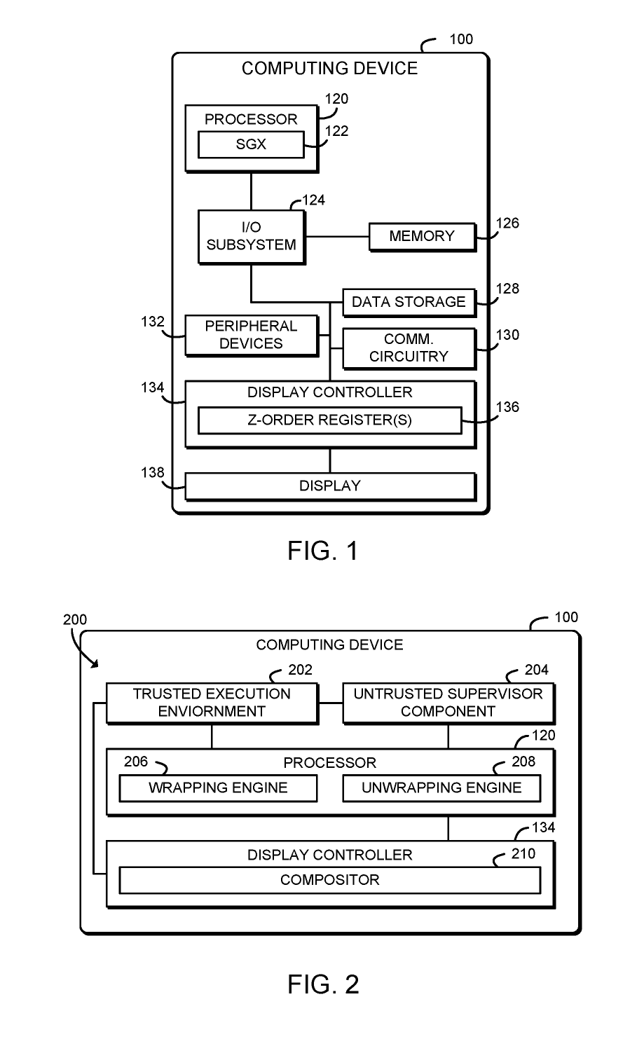

Referring now to FIG. 1, in an illustrative embodiment, a computing device 100 for secure z-order enforcement includes, among other components, a processor 120, main memory 126, and a display controller 134. In use, a trusted execution environment of the computing device 100, such as an Intel SGX secure enclave, configures a z-order enforcement policy that indicates whether z-order enforcement is requested. The trusted execution environment securely wraps the z-order enforcement policy and delivers the wrapped policy to an untrusted supervisor component such as an operating system driver. The untrusted component unwraps the policy and programs the display controller 134 with the z-order enforcement policy. If z-order enforcement is requested and successfully programmed, the display controller 134 ensures that a display surface associated with the trusted execution environment is rendered in front of all other display surfaces (i.e., not obscured by any other display surface). The wrapping, unwrapping, and programming of the z-order enforcement policy are performed by the processor 120, which provides a hardware root of trust. Thus, the computing device 100 may allow a trusted execution environment to securely control z-order enforcement. Secure z-order enforcement may protect certain interactive applications (e.g., banking applications) from having their graphical output obscured by malicious applications or other untrusted software.

The computing device 100 may be embodied as any type of computation or computer device capable of performing the functions described herein, including, without limitation, a computer, a desktop computer, a workstation, a server, a laptop computer, a notebook computer, a tablet computer, a mobile computing device, a wearable computing device, a network appliance, a web appliance, a distributed computing system, a processor-based system, and/or a consumer electronic device. As shown in FIG. 1, the computing device 100 illustratively includes a processor 120, an input/output subsystem 124, a memory 126, a data storage device 128, and communication circuitry 130. Of course, the computing device 100 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 126, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. As shown, the processor 120 includes secure enclave support 122. The secure enclave support 122 allows the processor 120 to establish a trusted execution environment known as a secure enclave, in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 126. The secure enclave support 122 may be embodied as a set of processor instruction extensions that allows the processor 120 to establish one or more secure enclaves in the memory 126. For example, the secure enclave support 122 may be embodied as Intel® Software Guard Extensions (SGX) technology.

The memory 126 may be embodied as any type of volatile or non-volatile memory or data storage capable of performing the functions described herein. In operation, the memory 126 may store various data and software used during operation of the computing device 100 such as operating systems, applications, programs, libraries, and drivers. The memory 126 is communicatively coupled to the processor 120 via the I/O subsystem 124, which may be embodied as circuitry and/or components to facilitate input/output operations with the processor 120, the memory 126, and other components of the computing device 100. For example, the I/O subsystem 124 may be embodied as, or otherwise include, memory controller hubs, input/output control hubs, platform controller hubs, integrated control circuitry, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processor 120, the memory 126, and other components of the computing device 100, on a single integrated circuit chip.

The data storage device 128 may be embodied as any type of device or devices configured for short-term or long-term storage of data such as, for example, memory devices and circuits, memory cards, hard disk drives, solid-state drives, or other data storage devices. In some embodiments, the data storage device 128 may be used to store the contents of one or more secure enclaves. When stored by the data storage device 128, the contents of the secure enclave may be encrypted to prevent unauthorized access.

The communication circuitry 130 of the computing device 100 may be embodied as any communication circuit, device, or collection thereof, capable of enabling communications between the computing device 100 and other remote devices over a network. The communication circuitry 130 may be configured to use any one or more communication technology (e.g., wired or wireless communications) and associated protocols (e.g., Ethernet, Bluetooth®, Wi-Fi®, WiMAX, etc.) to effect such communication.

As shown, the computing device 100 may further include one or more peripheral devices 132, a display controller 134, and a display 138. The display controller 134 may be embodied as any card, controller circuit, IP core, functional block, or other component capable of retrieving graphics data from the memory 126 and outputting display signals to the display 138. As described further below, display controller 134 may composite multiple overlay surfaces into a single output image and may enforce an always-on-top z-order for one or more of the overlay surfaces. The display controller 134 also includes one or more z-order status registers 136. The z-order status register(s) 136 indicate whether a z-order enforcement session is active. The display controller 134, along with 2D and 3D graphics rendering components and media processing components, may be integrated with the processor 120 or otherwise form a portion of an SoC. The display 138 of the computing device 100 may be embodied as any type of display capable of displaying digital information such as a liquid crystal display (LCD), a light emitting diode (LED), a plasma display, a cathode ray tube (CRT), or other type of display device.

The computing device 100 may further include one or more peripheral devices 132. The peripheral devices 132 may include any number of additional input/output devices, interface devices, and/or other peripheral devices. For example, in some embodiments, the peripheral devices 132 may include a touch screen, graphics circuitry, an audio device, a microphone, a camera, an environmental sensor, a keyboard, a mouse, and/or other input/output devices, interface devices, and/or peripheral devices.

Referring now to FIG. 2, in an illustrative embodiment, the computing device 100 establishes an environment 200 during operation. The illustrative environment 200 includes a trusted execution environment 202, an untrusted supervisor component 204, the processor 120, and the display controller 134. The processor 120 further includes a wrapping engine 206 and an unwrapping engine 208, and the display controller 134 further includes a compositor 210. The various components of the environment 200 may be embodied as hardware, firmware, microcode, software, or a combination thereof. As such, in some embodiments, one or more of the modules of the environment 200 may be embodied as circuitry or collection of electrical devices (e.g., trusted execution environment circuitry 202, untrusted supervisor component circuitry 204, wrapping engine circuitry 206, unwrapping engine circuitry 208, and/or compositor circuitry 210). It should be appreciated that, in such embodiments, one or more of the trusted execution environment circuitry 202, the untrusted supervisor component circuitry 204, the wrapping engine circuitry 206, the unwrapping engine circuitry 208, and/or the compositor circuitry 210 may form a portion of one or more of the processor 120, the I/O subsystem 124, the display controller 134, and/or other components of the computing device 100. Additionally, in some embodiments, one or more of the illustrative components may form a portion of another component and/or one or more of the illustrative components may be independent of one another.

The trusted execution environment 202 is illustratively an SGX secure enclave including user-level (e.g., ring-3) code protected with the secure enclave support 122 of the processor 120. In other embodiments, the trusted execution environment 202 may be embodied as any trusted application or other trusted component of the computing device 100. The trusted execution environment 202 is configured to invoke an EBIND processor instruction with display programming information that includes a z-order enforcement policy. The z-order enforcement policy indicates whether the trusted execution environment 202 requests z-order enforcement for an overlay surface associated with the trusted execution environment 202. Requesting z-order enforcement for the overlay surface includes requesting that the overlay surface associated with the trusted execution environment 202 is composited in front of all other overlay surfaces.

The trusted execution environment 202 may be further configured to encrypt graphics data with a bitmap encryption key (BEK) to generate encrypted graphics data and output the encrypted graphics data to the overlay surface associated with the trusted execution environment 202. The trusted execution environment 202 may be further configured to receive an authenticated response from the untrusted supervisor component 204, determine whether the authenticated response is authentic, and determine whether the authenticated response indicates that the display controller 134 was programmed successfully.

The untrusted supervisor component 204 may be embodied as an operating system driver, operating system, virtual machine monitor, or other supervisor-level (e.g., ring-0) component of the computing device 100. The untrusted supervisor component 204 may not be included in the trusted code base of the trusted execution environment 202. The untrusted supervisor component 204 is configured to invoke an UNWRAP processor instruction with the wrapped programming information. The untrusted supervisor component 204 may be further configured to request the display controller 134 to use an overlay surface associated with the trusted execution environment 202. In some embodiments, the untrusted supervisor component 204 may request the display controller 134 to use a predetermined always-on-top overlay surface for the trusted execution environment 202.

The wrapping engine 206 is configured to generate wrapped programming information based on the display programming information in response to invocation of the EBIND processor instruction. The wrapped programming information includes a message authentication code over the z-order enforcement policy, and may include an encrypted BEK.

The unwrapping engine 208 is configured to program the display controller 134 with the z-order enforcement policy in response to invocation of the UNWRAP processor instruction. The unwrapping engine 208 may be further configured to generate an authenticated response that indicates that the display controller 134 was programmed successfully. The unwrapping engine 208 may be further configured to determine whether the z-order enforcement policy indicates that the trusted execution environment 202 requests z-order enforcement, and, if so, determine whether an overlay surface of the display controller 134 is available for z-order enforcement. The unwrapping engine 208 may be configured to program the display controller 134 with the z-order enforcement policy if the overlay surface is available. Programming the display controller 134 with the z-order enforcement policy may include setting a z-order enforcement bit for the overlay surface associated with the trusted execution environment 202. The unwrapping engine 208 may be further configured to generate an authenticated response that indicates an error if the overlay surface is not available. The unwrapping engine 208 may be further configured to program the display controller 134 with the BEK in response to invoking the UNWRAP processor instruction.

The compositor 210 is configured to enforce the z-order enforcement policy in response to programming the display controller 134. Enforcing the z-order enforcement policy may include determining whether a z-order enforcement bit associated with any overlay surface of the display controller 134 is set, and composing an overlay surface with the associated z-order enforcement bit set in front of all other overlay surfaces of the display controller 134. The overlay surface with the associated z-order enforcement bit set may be the overlay surface associated with the trusted execution environment 202.

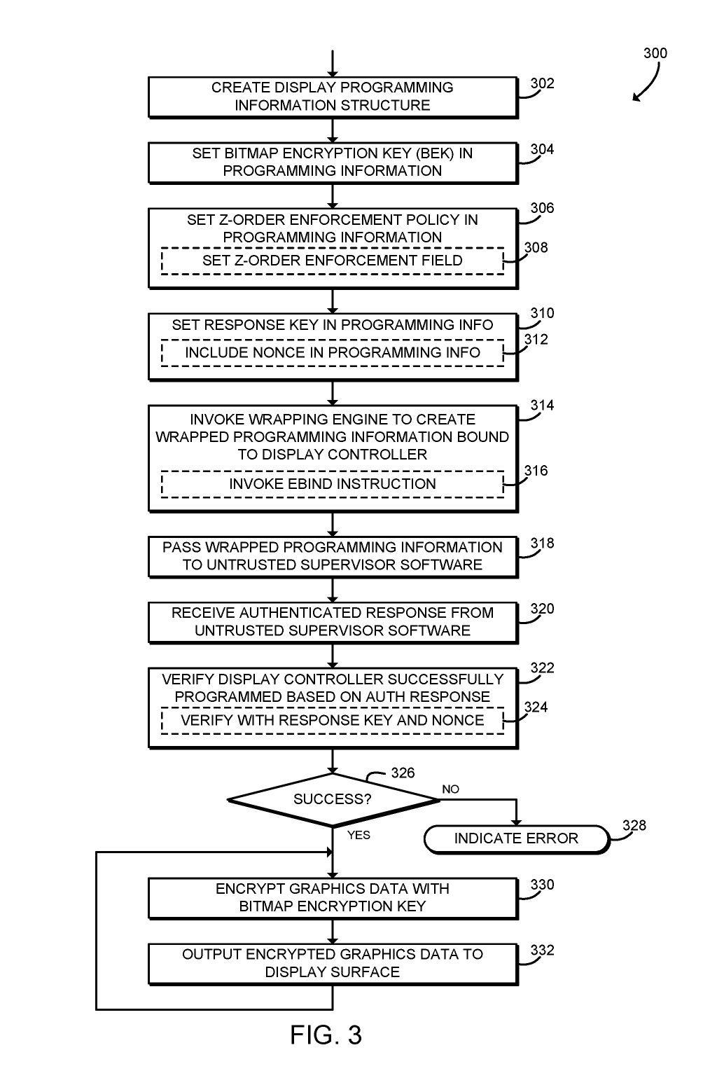

Referring now to FIG. 3, in use, the computing device 100 may execute a method 300 for trusted display with z-order enforcement. It should be appreciated that, in some embodiments, the operations of the method 300 may be performed by one or more components of the environment 200 of the computing device 100 as shown in FIG. 2, such as the trusted execution environment 202. The method 300 begins with block 302, in which the trusted execution environment 202 creates a display programming structure. Because the display programming information is created within the trusted execution environment 202, the contents of the display programming information are protected from unauthorized access by untrusted components of the computing device 100. For example, the display programming information may be created within an SGX secure enclave that is protected from unauthorized access by the secure enclave support 122 of the processor 120. In the illustrative embodiment, the display programming structure is embodied as a BIND_STRUCT data structure, which may include fields as described below in Table 1.

TABLE 1
Bind key structure (BIND_STRUCT).

| Name of Offset | Offset | Size (B) | Description | Set by |
|---|---|---|---|---|
| BTID | 0 | 2 | Target device | Software |
| BTSVN | 2 | 2 | Target security | Software |
| | | | version number | |
| BTPOLICY | 4 | 4 | Target device policy | Software |
| TKEY | 8 | 32 | Target Key (BEK and/or | Software/ |
| | | | response key) | hardware |
| SEQID | 40 | 8 | Seed for generating | Hardware |
| | | | initialization vector (IV) | |
| MAC | 48 | 16 | MAC on encrypted key, | Hardware |
| | | | target ID, policy, | |
| | | | and SVN | |

The bind target ID (BTID) field in BIND_STRUCT is set up by the trusted execution environment 202, which will eventually invoke a processor instruction to program to a target device, which is illustratively the display controller 134. The BTID field is set to the identifier of the target device (e.g., the display controller 134) to enable the unwrapping engine 208 to direct the programming to the desired target device. The bind target security version number (BTSVN) field is set up by the invoking entity and contains the security version number (SVN) for any firmware running on the endpoint device (e.g., the display controller 134). In the illustrative embodiment, the display controller 134 of the computing device 100 may not include any firmware and thus the BTSVN field must be zero (MBZ).

The bind target policy (BTPOLICY) field is set up by the trusted execution environment 202 and includes the requested z-order enforcement policy as well as any other policies that must be applied by the display controller 134. The z-order enforcement policy may be embodied as a bit within the BTPOLICY field that may be set if the trusted execution environment 202 requests z-order enforcement. Other bits and/or sub-fields of the BTPOLICY may be used to specify other policies, such as whether an integrated display interface is allowed (e.g., for laptops, smart phones, tablets, or other devices with an integrated display 138), whether a memory-based display interface is allowed (e.g., WiDi or USB display), whether High-Definition Multimedia Interface (HDMI) with High-bandwidth Digital Content Protection (HDCP) output is allowed, whether HDMI without HDCP output is allowed, or other display policies.

The TKEY field is set up by the trusted execution environment 202 and may include a bitmap encryption key (BEK) to be programmed to the display controller 134 and/or a response key that may be used by the processor 120 to generate an authenticated response. As described further below, the BEK may be used to protect graphics data output from the trusted execution environment 202 to the display controller 134.

As shown, the BIND_STRUCT structure may also include fields that are set by hardware of the processor 120, including a sequence number (SEQID) and a message authentication code (MAC). Generation of those fields by the processor 120 is described further below. Of course, the BIND_STRUCT structure illustrates one potential embodiment of the display programming information, and the programming information may be stored in different formats in other embodiments. For example, in some embodiments, the programming information may include variable amounts of target-specific data and/or wrapped data, as well as associated size fields that may be interpreted by the processor 120.

In block 304, the trusted execution environment 202 sets a bitmap encryption key (BEK) in the display programming information. As described further below, the BEK may be embodied as a symmetric encryption key used to protect graphics data output from the trusted execution environment 202 to the display controller 134. As described above, the BEK may be stored in the TKEY field of the BIND_STRUCT data structure. The trusted execution environment 202 may also generate a response key to verify an authenticated response generated by the unwrapping engine 208, as described further below.

In block 306, the trusted execution environment 202 sets a z-order enforcement policy in the display programming information. The z-order enforcement policy indicates whether the trusted execution environment 202 has requested that its graphics data be presented in front of all other graphics data composited by the display controller 134. For example, a banking application or other sensitive application may request always-on-top z-order enforcement in order to prevent malicious applications from presenting false graphical information that obscures the application window of the trusted execution environment 202. In some embodiments, in block 308, the trusted execution environment 202 may set a z-enforcement policy bit in the display programming information to request graphics data be displayed in front of all other graphics data.

In block 310, the trusted execution environment 202 may set a response key in the display programming information. As described further below, the response key may be used to verify an authenticated response received from the processor 120 after programming the display controller 134. The response key may be embodied as any cryptographic key that is private to the trusted execution environment. In some embodiments, the BEK may be used as the response key. In some embodiments, in block 312, the trusted execution environment 202 may include a random nonce value in the display programming information. The nonce may be used for replay protection.

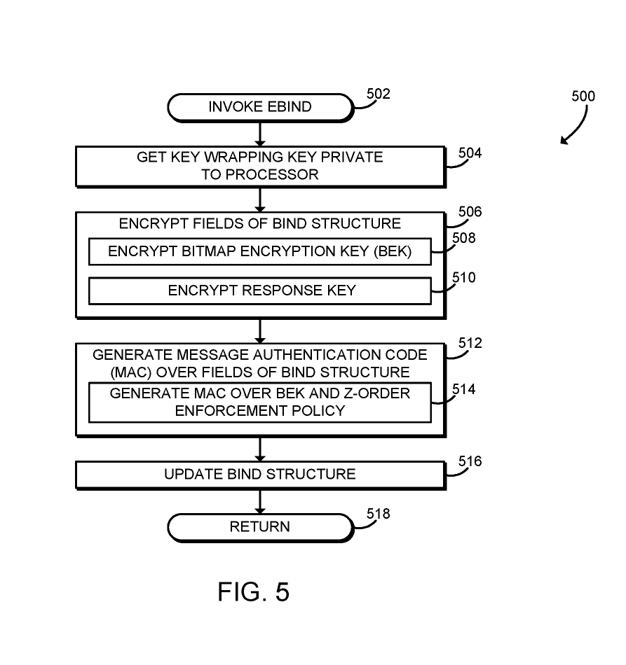

In block 314, the trusted execution environment 202 invokes the wrapping engine 206 of the processor 120 to wrap the display programming information. The wrapping engine 206 generates wrapped display programming information that is bound to the display controller 134. One potential embodiment of a method for wrapping the display programming information is described below in connection with FIG. 5. In some embodiments, in block 316 the trusted execution environment 202 may execute an EBIND instruction to invoke the wrapping engine 206.

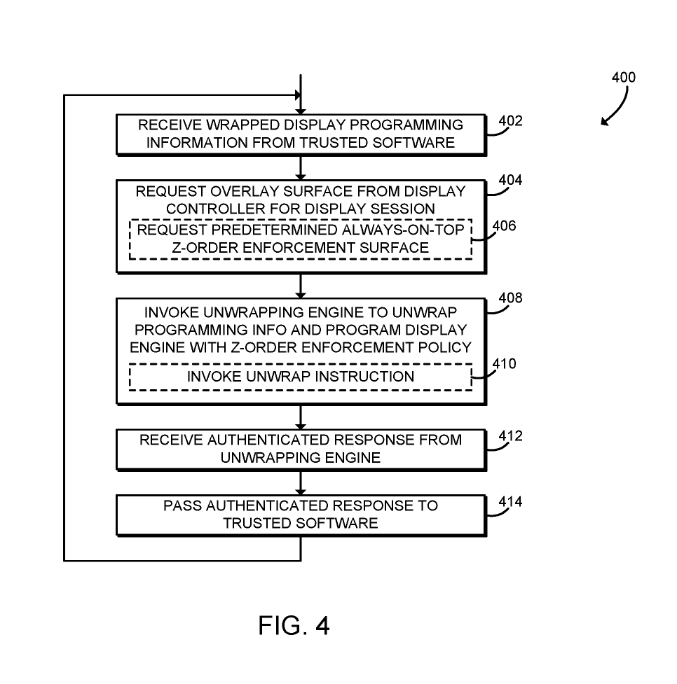

In block 318, the trusted execution environment 202 passes the wrapped programming information to the untrusted supervisor component 204. Because the wrapped programming information has been encrypted and bound to the display controller 134, sensitive data in the display programming information (e.g., the BEK) may not be accessed by untrusted software. The untrusted software may inspect unprotected fields of the wrapped programming information (e.g., the BTPOLICY fields) to determine whether to allow the programming attempt. Thus, kernel-mode software such as a device driver or other supervisor component may manage programming of the display controller without being trusted or otherwise capable of accessing protected graphics data. As described further below in connection with FIG. 4, after being passed the wrapped programming information, the untrusted supervisor component 204 causes the processor 120 to unwrap the programming information and program the display controller 134.

In block 320, the trusted execution environment 202 receives an authenticated response from the untrusted supervisor component 204. As described further below, after programming the display controller 134, the unwrapping engine 208 generates an authenticated response indicating the programming status and/or the unwrapping status. For example, the authenticated response may indicate whether the wrapped programming information was successfully unwrapped and/or whether the display controller 134 was successfully programmed with the z-order enforcement policy.

In block 322, the trusted execution environment 202 uses the authenticated response to verify that the display controller 134 was successfully programmed Verifying the authenticated response allows the trusted execution environment 202 to determine whether the authenticated response was generated by the unwrapping engine 208 and has not been tampered with. Thus, after verifying the authenticated response, the trusted execution environment 202 may examine one or more fields of the authenticated response to determine whether the display controller 134 was successfully programmed. The trusted execution environment 202 may use any appropriate technique to cryptographically verify that the authenticated response. In some embodiments, in block 324 the trusted execution environment 202 may verify the authenticated response with the response key and, in some embodiments, the nonce that were provided with the wrapped programming information. For example, the authenticated response may include a message authentication code over the programming status that can be verifying using the response key and the random nonce.

In block 326, the trusted execution environment 202 determines whether the display controller 134 was successfully programmed. If not, the method 300 branches to block 328, in which the trusted execution environment 202 indicates an error. After indicating the error, the method 300 is completed; thus, the trusted execution environment 202 may not output graphics data if the z-enforcement policy was not successfully programmed. Referring back to block 326, if the display controller 134 was successfully programmed, then the method 300 advances to block 330.

In block 330, the trusted execution environment 202 encrypts graphics data with the BEK. The graphics data may include graphical user interface data, video data, or any other graphics data generated by the trusted execution environment 202 for output to the display 138. In block 332, the trusted execution environment 202 outputs the encrypted graphics data to a display surface for output to the display controller 134. The display surface may be embodied as a range of memory that is read by the display controller 134 and used to output graphics to the display controller 134. Because the display surface is encrypted, the contents of the display surface are protected from unauthorized disclosure. After outputting the encrypted graphics data, the method 300 loops back to block 330 to continue generating encrypted data. The trusted execution environment 202 may continue generating encrypted data until the trusted display session is closed.

Referring now to FIG. 4, in use, the computing device 100 may execute a method 400 for display controller device management. It should be appreciated that, in some embodiments, the operations of the method 400 may be performed by one or more components of the environment 200 of the computing device 100 as shown in FIG. 2, such as the untrusted supervisor component 204. The method 400 begins with block 402, in which the untrusted supervisor component 204 receives wrapped display programming information from the trusted execution environment 202. As described above in connection with FIG. 3, the wrapped display programming information is generated by the processor 120 at the request of the trusted execution environment 202, and may include one or more encrypted keys (e.g., an encrypted bitmap encryption key and/or response key), a z-order enforcement policy, and a message authentication code.

In block 404, the untrusted supervisor component 204 requests an overlay surface from the display controller 134 for the trusted execution environment to use for a display session. The overlay surface may be embodied as a region in the memory 126 that stores graphics information that may be output by the display controller 134 to the display 138 (e.g., a frame buffer, bitmap, or other graphics data). As described above, the graphics data may be encrypted with the BEK, protecting the graphics data from the untrusted supervisor component 204. Although the untrusted supervisory component cannot access unencrypted graphics data, the untrusted supervisor component 204 does retain control over assigning overlay surfaces to various processes of the computing device 100. Additionally, because the z-order enforcement policy of the wrapped programming information is integrity-protected but not encrypted, the untrusted supervisor component 204 may determine whether the trusted execution environment 202 has requested z-order enforcement. In some embodiments, in block 406 the untrusted supervisor component 204 may request a predetermined always-on-top z-order enforcement surface from the display controller 134. For example, certain display controllers 134 may support seven overlay surfaces, numbered one through seven, and the overlay surface number seven may always be composited in front of the other surfaces.

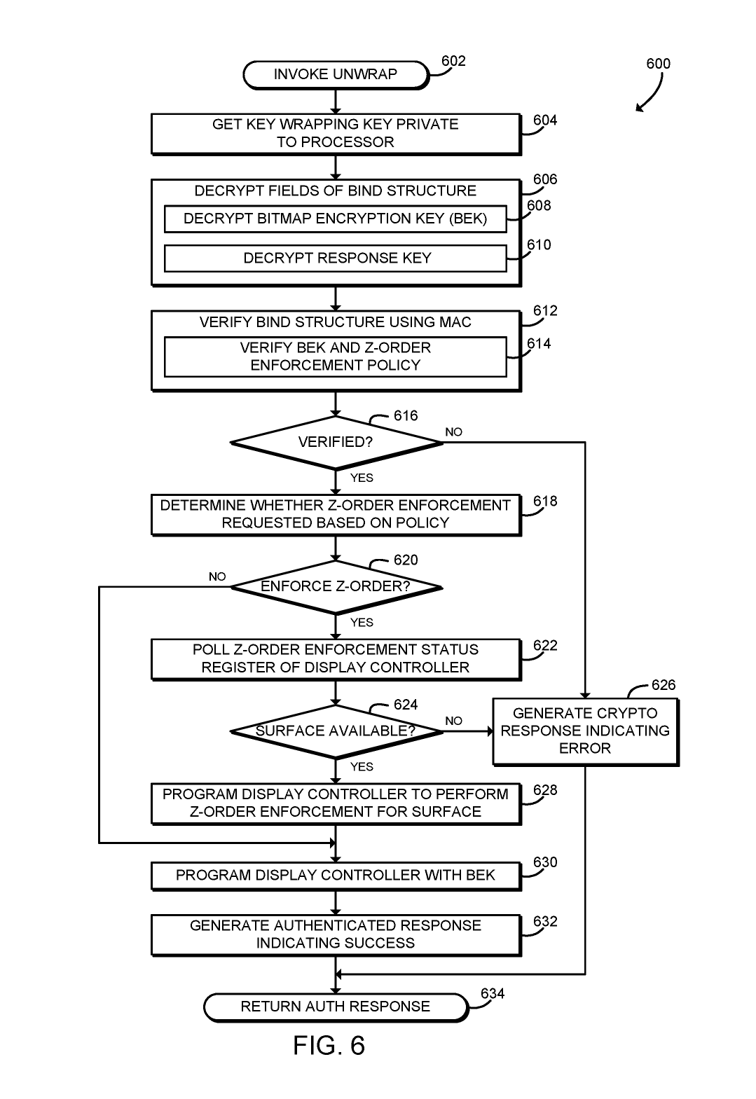

In block 408, the untrusted supervisor component 204 invokes the unwrapping engine 208 of the processor 120 to unwrap the wrapped programming information and program the display controller 134 with the z-order enforcement policy. For example, the untrusted supervisor component 204 may invoke a processor instruction that causes the unwrapping engine 208 of the processor 120 to verify the display programming information and, if verified, program the display controller 134 with the z-order enforcement policy. The unwrapping engine 208 may also program the display controller 134 with the bitmap encryption key (BEK) or other display programming information. One potential embodiment of a method for unwrapping the wrapped programming information and programming the display controller 134 is described below in connection with FIG. 6. In some embodiments, in block 410 the untrusted supervisor component 204 may execute an UNWRAP instruction to invoke the unwrapping engine 208.

In block 412, the untrusted supervisor component 204 receives an authenticated response from the unwrapping engine 208 of the processor 120. As described below in connection with FIG. 6, the processor 120 generates the authenticated response to indicate whether the display controller 134 was programmed successfully. In block 414, the untrusted supervisor component 204 passes the authenticated response to the trusted execution environment 202. As described above in connection with FIG. 3, the trusted execution environment 202 may use the authenticated response to verify that the display controller 134 was programmed successfully. Note that the untrusted supervisor component 204 may also evaluate unencrypted fields of the authenticated response, such as a programming status code and/or an unwrapping status code. After passing the authenticated response to the trusted execution environment 202, the method 400 loops to block 402, in which the untrusted supervisor component 204 may receive further wrapped display programming information.

Referring now to FIG. 5 in use, the computing device 100 may execute a method 500 for display programming information wrapping. It should be appreciated that, in some embodiments, the operations of the method 500 may be performed by hardware, firmware, processor microcode, and/or other execution resources of the processor 120, such as the wrapping engine 206 shown in FIG. 2. Thus, the method 500 may have a hardware root of trust (i.e., the processor 120). The method 500 begins with block 502, in which the computing device 100 invokes the EBIND instruction. The EBIND instruction may be embodied as a user-level (e.g., ring 3) instruction. The EBIND instruction is invoked with display programming information as a parameter. For example, a pointer to a BIND_STRUCT data structure may be provided in a register of the processor 120 such as RCX.

In block 504, the processor 120 retrieves a key wrapping key that is private to the processor 120. For example, the key wrapping key may be generated by the processor 120 during boot and stored securely by the processor 120. In block 506, the processor 120 encrypts one or more fields of the BIND_STRUCT with the key wrapping key. In the illustrative embodiment, the processor 120 encrypts the fields of the BIND_STRUCT using the Advanced Encryption Standard-Galois/Counter Mode (AES-GCM) algorithm. Of course, the processor 120 may use any appropriate cryptographic algorithm to encrypt the fields. In block 508, the processor 120 encrypts the bitmap encryption key (BEK). In block 510, the processor 120 encrypts the response key. Of course, in some embodiments, the BEK may also be used as the response key, and thus the processor 120 may encrypt a single key.

In block 512, the processor 120 generates a message authentication code (MAC) over one or more fields of the BIND_STRUCT. In block 514, the processor 120 generates the MAC over the encrypted BEK and the z-order enforcement policy of the BIND_STRUCT. The MAC may also be generated over one or more additional fields, such as the BIND_STRUCT fields BTID, BTSVN, BTPOLICY, SEQID, and/or other data, such as a random nonce. The MAC is stored in the MAC field of the BIND_STRUCT and, as described further below, allows the unwrapping engine 208 to verify that the wrapped programming information was not modified while transitioning through untrusted software of the computing device 100.

In block 516, the processor 120 updates the BIND_STRUCT. For example, the processor 120 may write the encrypted BEK to the TKEY field of the BIND_STRUCT (overwriting the plaintext BEK), and the processor 120 may write the MAC to a field of the BIND_STRUCT. The processor 120 may also update other fields of the BIND_STRUCT, such as the SEQID field. For example, the processor 120 may generate a sequence ID on each EBIND invocation by using an internally maintained monotonic counter and store the sequence ID in the SEQID field of the BIND_STRUCT data structure. The sequence ID may be used to construct an initialization vector for the cryptographic wrapping, and may be used for replay protection.

In block 518, the processor 120 returns from executing the EBIND instruction. After executing the EBIND instruction, the memory 126 includes the wrapped programming information. For example, the SEQID, TKEY, and MAC fields of the BIND_STRUCT may include values stored by the processor 120 during execution of the EBIND instruction. After returning, the method 500 is complete. As described above in connection with FIG. 3, after executing the EBIND instruction, the trusted execution environment 202 may read the wrapped display programming information.

Referring now to FIG. 6 in use, the computing device 100 may execute a method 600 for display programming information unwrapping. It should be appreciated that, in some embodiments, the operations of the method 600 may be performed by hardware, firmware, processor microcode, and/or other execution resources of the processor 120, such as the unwrapping engine 208 shown in FIG. 2. Thus, the method 600 may have a hardware root of trust (i.e., the processor 120). The method 600 begins with block 602, in which the computing device 100 invokes the UNWRAP instruction. The UNWRAP instruction may be embodied as a kernel-level (e.g., ring 0) instruction. In some embodiments, the UNWRAP instruction may generate a virtual machine exit (VMExit), allowing a virtual machine monitor (VMM) and/or hypervisor to manage virtualization of the UNWRAP instruction. The UNWRAP instruction may be invoked with wrapped display programming information as a parameter. For example, a pointer to a wrapped BIND_STRUCT data structure may be provided in a register of the processor 120 such as RCX.

In block 604, the processor 120 retrieves a key wrapping key that is private to the processor 120. The key wrapping key used for unwrapping may be embodied as the same key used to wrap the display programming information as described above in connection with block 504 of FIG. 5. For example, the key wrapping key may be generated by the processor 120 during boot and stored securely by the processor 120.

In block 606, the processor 120 decrypts one or more fields of the BIND_STRUCT with the key wrapping key. In the illustrative embodiment, the processor 120 decrypts the fields of the BIND_STRUCT using the AES-GCM algorithm Of course, the processor 120 may use any appropriate cryptographic algorithm to decrypt the fields. In block 608, the processor 120 decrypts the bitmap encryption key (BEK), which may be stored in the TKEY field of the BIND_STRUCT. In block 610, the processor 120 decrypts the response key, which may also be stored in the TKEY field of the BIND_STRUCT. Of course, in some embodiments, the BEK may be used as the response key, and thus the processor 120 may decrypt a single key.

In block 612, the processor 120 verifies the BIND_STRUCT data structure using the message authentication code (MAC) included as a field of the BIND_STRUCT. For example, the processor 120 may verify the MAC over the BEK key (or encrypted BEK), the z-order policy, and other BIND_STRUCT fields using an authenticated encryption algorithm such as AES-GCM. In block 614, the processor 120 verifies the BEK and the z-order enforcement policy of the wrapped display programming information, which may be included in the TKEY and BTPOLICY fields of the BIND_STRUCT, respectively. The processor 120 may also verify the MAC over other BIND_STRUCT fields such as BTID, BTSVN, and SEQID. Of course, the processor 120 may use any appropriate cryptographic algorithm to verify that the wrapped programming information has not been modified while transitioning through untrusted software.

In block 616, the processor 120 determines whether the BIND_STRUCT was successfully verified. If so, the method 600 advances to block 618, described below. If the BIND_STRUCT was not successfully verified, the method 600 branches to block 626, in which the processor 120 generates an authenticated response indicating an error. For example, the processor 120 may write an appropriate error code in a response structure in the memory 126, and the processor 120 may generate a MAC over the response structure using the response key or otherwise authenticate the response structure. After generating the authenticated response, the method 600 advances to block 634, described below.

Referring back to block 616, if the BIND_STRUCT was successfully verified, the method 600 advances to block 620, in which the processor 120 determines whether the z-order enforcement policy requests z-order enforcement. For example, the processor 120 may examine a bit or other sub-field of the BTPOLICY field of the BIND_STRUCT data structure. In block 620, the processor 120 determines whether to enforce z-order. If not, the method 600 branches ahead to block 630, described below. If the processor 120 determines to enforce z-order, the method 600 advances to block 622.

In block 622, the processor 120 polls a z-order status register 136 of the display controller 134 to determine whether an overlay surface is available for z-order enforcement. The display controller 134 may provide z-order enforcement for only a single overlay surface at a time. Thus, the z-order status register 136 may be cleared if no overlay surface is currently being used for z-order enforcement and may be set if any overlay surface is being used for z-order enforcement. In block 624, the processor 120 checks whether the surface is available. If not, the method 600 branches to block 626, in which the processor 120 generates an authenticated response indicating an error, as described above. If the overlay surface is available for z-order enforcement, the method 600 advances to block 628.

In block 628, the processor 120 programs the display controller 134 to perform z-order enforcement for a selected overlay surface. The processor 120 may use any technique to program the display controller 134. For example, the processor 120 may set one or more registers of the display controller 134 using a sideband interface that is unavailable to software executed by the processor 120. Similarly, in block 630, the processor 120 programs the display controller 134 with the BEK.

In block 632, the processor 120 generates an authenticated response indicating that the display controller 134 was programmed successfully. The authenticated response allows the trusted execution environment 202 to verify that the untrusted supervisor component 204 actually initiated the display controller 134 programming by calling UNWRAP and to verify that display controller 134 was programmed successfully. For example, the authenticated response may include a status code or other indication that the display controller 134 was programmed successfully and may be authenticated and/or encrypted using the response key. The authenticated response indicates that the programming was performed using the UNWRAP instruction, because only the processor 120 (e.g., the unwrapping engine 208) may recover the response key and generate a MAC using this key. Additionally, the authenticated response cannot be modified by untrusted software without detection, as MAC verification by the trusted execution environment 202 will fail if there was an attempt to modify the authenticated response. In block 634, the processor 120 returns the authenticated response. After returning the authenticated response, the method 600 is complete. As described above, the authenticated response may be read by the untrusted supervisor component 204 and passed to the trusted execution environment 202 for verification.

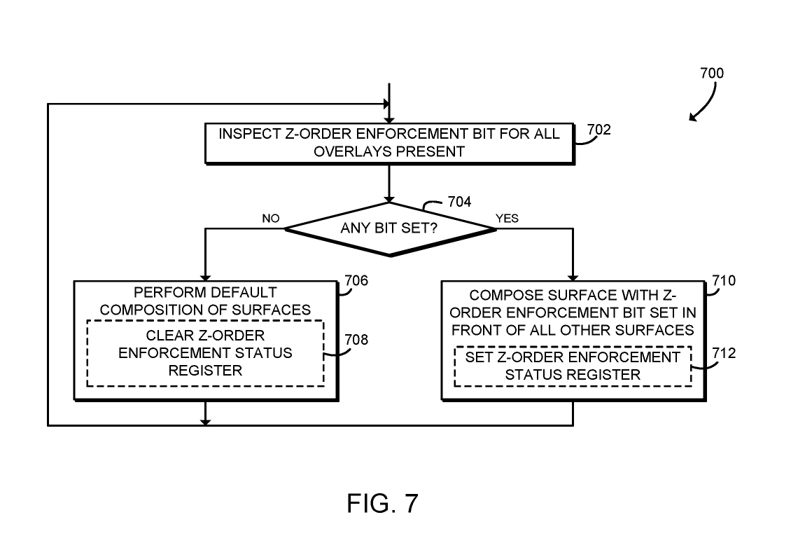

Referring now to FIG. 7 in use, the computing device 100 may execute a method 700 for display compositing with configurable z-order enforcement. It should be appreciated that, in some embodiments, the operations of the method 700 may be performed by hardware, firmware, and/or other resources of the display controller 134, such as the compositor 210 shown in FIG. 2. Thus, the method 700 may have a hardware root of trust (i.e., the display controller 134). The method 700 begins with block 702, in which the display controller 134 inspects a z-order enforcement bit for each of the overlay surfaces present in the display controller 134. The z-order enforcement bit for an overlay surface may be set if z-order enforcement has been programmed for that overlay surface (e.g., if that overlay surface is currently performing a z-order enforcement display session).

In block 704, the display controller 134 determines whether any z-order enforcement bit is set. If not, the method 700 branches to block 706, in which the display controller 134 performs default composition of surfaces without any z-order enforcement. In other words, the display controller 134 may not ensure that any particular display surface is composited in front of all other display surfaces. In some embodiments, in block 708 the display controller 134 may clear a z-order enforcement status register 136. As described above, clearing the z-order enforcement status register 136 may indicate that a display surface is available for z-order enforcement. After composing the surfaces, the method 700 loops back to block 702 to continue to check for z-order enforcement.

Referring back to block 704, if any the z-order enforcement bit for any display surface is set, the method 700 branches to block 710, in which the display controller 134 composes the overlay surface with the z-order enforcement bit set in front of all other overlay surfaces. In other words, the graphics data of the overlay surface that has been programmed for z-order enforcement is not obscured by graphics data from any other overlay surface or other graphics data. In some embodiments, in block 712, the display controller 134 may set the z-order enforcement status register 136. As described above, setting the z-order enforcement status register 136 indicates that no overlay surface is available for z-order enforcement, and attempts to program the display controller 134 to start a new z-order enforcement session will fail. Note that because the unwrapping engine 208 checks the z-order enforcement status register 136 before programming the display controller 134, only a single overly surface should have the z-order enforcement bit set at any time. The behavior of the display controller 134 when multiple overlay surfaces have the z-order enforcement bit set may be undefined. After composing the surfaces, the method 700 loops back to block 702 to continue to check for z-order enforcement.

It should be appreciated that, in some embodiments, the methods 300, 400, 500, 600, and/or 700 may be embodied as various instructions stored on a computer-readable media, which may be executed by the processor 120, the display controller 134, and/or other components of the computing device 100 to cause the computing device 100 to perform the corresponding method 300, 400, 500, 600, and/or 700. The computer-readable media may be embodied as any type of media capable of being read by the computing device 100 including, but not limited to, the memory 126, the data storage device 128, microcode of the processor 120, firmware of the display controller 134, and/or other media.

### EXAMPLES

Illustrative examples of the technologies disclosed herein are provided below. An embodiment of the technologies may include any one or more, and any combination of, the examples described below.

Example 1 includes a computing device for secure display z-order enforcement, the computing device comprising: a display controller; a trusted execution environment to invoke a first processor instruction with display programming information that includes a z-order enforcement policy, wherein the z-order enforcement policy indicates whether the trusted execution environment requests z-order enforcement for an overlay surface associated with the trusted execution environment; a processor that includes a wrapping engine to generate wrapped programming information based on the display programming information in response to invocation of the first processor instruction, wherein the wrapped programming information comprises a message authentication code over the z-order enforcement policy; and an untrusted supervisor component to invoke a second processor instruction with the wrapped programming information; wherein the processor further includes an unwrapping engine to program the display controller with the z-order enforcement policy in response to invocation of the second processor instruction.

Example 2 includes the subject matter of Example 1, and wherein to request z-order enforcement for the overlay surface comprises to request that the overlay surface associated with the trusted execution environment be composited in front of all other overlay surfaces.

Example 3 includes the subject matter of any of Examples 1 and 2, and wherein the display controller further comprises a compositor to enforce the z-order enforcement policy in response to programming of the display controller.

Example 4 includes the subject matter of any of Examples 1-3, and wherein to enforce the z-order enforcement policy comprises to: determine whether a z-order enforcement bit associated with any overlay surface of the display controller is set; and compose an overlay surface with the associated z-order enforcement bit set in front of all other overlay surfaces of the display controller, wherein the overlay surface with the associated z-order enforcement bit set is the overlay surface associated with the trusted execution environment.

Example 5 includes the subject matter of any of Examples 1-4, and wherein: the first processor instruction comprises an EBIND instruction; and the second processor instruction comprises an UNWRAP instruction.

Example 6 includes the subject matter of any of Examples 1-5, and wherein: the unwrapping engine is further to (i) determine whether the z-order enforcement policy indicates that the trusted execution environment requests z-order enforcement in response to the invocation of the second processor instruction, and (ii) determine whether an overlay surface of the display controller is available for z-order enforcement in response to a determination that the z-order enforcement policy indicates that the trusted execution environment requests z-order enforcement; wherein to program the display controller with the z-order enforcement policy comprises to program the display controller with the z-order enforcement policy in response to a determination that the overlay surface is available.

Example 7 includes the subject matter of any of Examples 1-6, and wherein to determine whether the overlay surface of the display controller is available for z-order enforcement comprises to read a z-order enforcement status register of the display controller, wherein the z-order enforcement status register indicates whether any overlay surface of the display controller has a z-order enforcement bit set.

Example 8 includes the subject matter of any of Examples 1-7, and wherein to program the display controller with the z-order enforcement policy comprises to set the z-order enforcement bit for the overlay surface associated with the trusted execution environment.

Example 9 includes the subject matter of any of Examples 1-8, and wherein the unwrapping engine is further to generate an authenticated response in response to a determination that the overlay surface is not available, wherein the authenticated response indicates an error.

Example 10 includes the subject matter of any of Examples 1-9, and wherein: the unwrapping engine is further to verify the message authentication code with a key wrapping key in response to the invocation of the second processor instruction, wherein the key wrapping key is a secret of the processor; to generate the wrapped programming information comprises to generate the message authentication code using the key wrapping key; and to program the display controller comprises to program the display controller in response to verification of the message authentication code.

Example 11 includes the subject matter of any of Examples 1-10, and wherein: the unwrapping engine is further to program the display controller with a bitmap encryption key in response to the invocation of the second processor instruction, wherein the display programming information includes the bitmap encryption key; and the trusted execution environment is further to (i) encrypt graphics data with the bitmap encryption key to generate encrypted graphics data, and (ii) output the encrypted graphics data to the overlay surface associated with the trusted execution environment in response to programming of the display controller with the z-order enforcement policy.

Example 12 includes the subject matter of any of Examples 1-11, and wherein: the unwrapping engine is further to generate an authenticated response in response to the programming of the display controller, wherein the authenticated response indicates that the display controller was programmed successfully; the trusted execution environment is further to (i) receive the authenticated response from the untrusted supervisor component, (ii) determine whether the authenticated response is authentic in response to receipt of the authenticated response, and (iii) determine whether the authenticated response indicates that the display controller was programmed successfully in response to a determination that the authenticated response is authentic; and to output the encrypted graphics data to the overlay surface comprises to output the encrypted graphics data to the overlay surface in response to a determination that the authenticated response indicates that the display controller was programmed successfully.

Example 13 includes the subject matter of any of Examples 1-12, and wherein the untrusted supervisor component is further to request the display controller to use the overlay surface associated with the trusted execution environment.

Example 14 includes the subject matter of any of Examples 1-13, and wherein: the untrusted supervisor component is further to determine whether the z-order enforcement policy indicates that the trusted execution environment requests z-order enforcement; and to request the display controller to use the overlay surface comprises to request the display controller to use a predetermined always-on-top overlay surface for the trusted execution environment in response to a determination that the z-order enforcement policy indicates that the trusted execution environment requests z-order enforcement.

Example 15 includes the subject matter of any of Examples 1-14, and wherein the processor further comprises secure enclave support to establish a secure enclave, wherein the secure enclave comprises the trusted execution environment.

Example 16 includes the subject matter of any of Examples 1-15, and wherein the untrusted supervisor component comprises a kernel mode operating system component.

Example 17 includes a method for secure display z-order enforcement, the method comprising: invoking, by a trusted execution environment of a computing device, a first processor instruction with display programming information that includes a z-order enforcement policy, wherein the z-order enforcement policy indicates whether the trusted execution environment requests z-order enforcement for an overlay surface associated with the trusted execution environment; generating, by a processor of the computing device, wrapped programming information based on the display programming information in response to invoking the first processor instruction, wherein the wrapped programming information comprises a message authentication code over the z-order enforcement policy; invoking, by an untrusted supervisor component of the computing device, a second processor instruction with the wrapped programming information; and programming, by the processor, a display controller of the computing device with the z-order enforcement policy in response to invoking the second processor instruction.

Example 18 includes the subject matter of Example 17, and wherein to request z-order enforcement for the overlay surface comprises to request that the overlay surface associated with the trusted execution environment be composited in front of all other overlay surfaces.

Example 19 includes the subject matter of any of Examples 17 and 18, and further comprising enforcing, by the display controller, the z-order enforcement policy in response to programming the display controller.

Example 20 includes the subject matter of any of Examples 17-19, and wherein enforcing the z-order enforcement policy comprises: determining whether a z-order enforcement bit associated with any overlay surface of the display controller is set; and composing an overlay surface with the associated z-order enforcement bit set in front of all other overlay surfaces of the display controller, wherein the overlay surface with the associated z-order enforcement bit set is the overlay surface associated with the trusted execution environment.

Example 21 includes the subject matter of any of Examples 17-20, and wherein: invoking the first processor instruction comprises invoking an EBIND instruction; and invoking the second processor instruction comprises invoking an UNWRAP instruction.

Example 22 includes the subject matter of any of Examples 17-21, and further comprising: determining, by the processor, whether the z-order enforcement policy indicates that the trusted execution environment requests z-order enforcement in response to invoking the second processor instruction; and determining, by the processor, whether an overlay surface of the display controller is available for z-order enforcement in response to determining that the z-order enforcement policy indicates that the trusted execution environment requests z-order enforcement; wherein programming the display controller with the z-order enforcement policy comprises programming the display controller with the z-order enforcement policy in response to determining that the overlay surface is available.

Example 23 includes the subject matter of any of Examples 17-22, and wherein determining whether the overlay surface of the display controller is available for z-order enforcement comprises reading a z-order enforcement status register of the display controller, wherein the z-order enforcement status register indicates whether any overlay surface of the display controller has a z-order enforcement bit set.

Example 24 includes the subject matter of any of Examples 17-23, and wherein programming the display controller with the z-order enforcement policy comprises setting the z-order enforcement bit for the overlay surface associated with the trusted execution environment.

Example 25 includes the subject matter of any of Examples 17-24, and further comprising generating, by the processor, an authenticated response in response to determining that the overlay surface is not available, wherein the authenticated response indicates an error.

Example 26 includes the subject matter of any of Examples 17-25, and further comprising: verifying, by the processor, the message authentication code using a key wrapping key in response to invoking the second processor instruction, wherein the key wrapping key is a secret of the processor; wherein generating the wrapped programming information comprises generating the message authentication code using the key wrapping key; and wherein programming the display controller comprises programming the display controller in response to verifying the message authentication code.

Example 27 includes the subject matter of any of Examples 17-26, and further comprising: programming, by the processor, the display controller with a bitmap encryption key in response to invoking the second processor instruction, wherein the display programming information includes the bitmap encryption key; encrypting, by the trusted execution environment, graphics data with the bitmap encryption key to generate encrypted graphics data; and outputting, by the trusted execution environment, the encrypted graphics data to the overlay surface associated with the trusted execution environment in response to programming the display controller with the z-order enforcement policy.

Example 28 includes the subject matter of any of Examples 17-27, and further comprising: generating, by the processor, an authenticated response in response to programming the display controller, wherein the authenticated response indicates that the display controller was programmed successfully; receiving, by the trusted execution environment, the authenticated response from the untrusted supervisor component; determining, by the trusted execution environment, whether the authenticated response is authentic in response to receiving the authenticated response; and determining, by the trusted execution environment, whether the authenticated response indicates that the display controller was programmed successfully in response to determining that the authenticated response is authentic; wherein outputting the encrypted graphics data to the overlay surface comprises outputting the encrypted graphics data to the overlay surface in response to determining that the authenticated response indicates that the display controller was programmed successfully.

Example 29 includes the subject matter of any of Examples 17-28, and further comprising requesting, by the untrusted supervisor component of the computing device, the display controller to use the overlay surface associated with the trusted execution environment.

Example 30 includes the subject matter of any of Examples 17-29, and further comprising: determining, by the untrusted supervisor component of the computing device, whether the z-order enforcement policy indicates that the trusted execution environment requests z-order enforcement; wherein requesting the display controller to use the overlay surface comprises requesting the display controller to use a predetermined always-on-top overlay surface for the trusted execution environment in response to determining that the z-order enforcement policy indicates that the trusted execution environment requests z-order enforcement.

Example 31 includes the subject matter of any of Examples 17-30, and further comprising establishing, by the processor of the computing device, a secure enclave with secure enclave support of the processor, wherein the secure enclave comprises the trusted execution environment.

Example 32 includes the subject matter of any of Examples 17-31, and wherein the untrusted supervisor component comprises a kernel mode operating system component.

Example 33 includes a computing device comprising: a processor; and a memory having stored therein a plurality of instructions that when executed by the processor cause the computing device to perform the method of any of Examples 17-32.

Example 34 includes one or more non-transitory, computer readable storage media comprising a plurality of instructions stored thereon that in response to being executed result in a computing device performing the method of any of Examples 17-32.

Example 35 includes a computing device comprising means for performing the method of any of Examples 17-32.

Example 36 includes a computing device for secure display z-order enforcement, the computing device comprising: means for invoking, by a trusted execution environment of the computing device, a first processor instruction with display programming information that includes a z-order enforcement policy, wherein the z-order enforcement policy indicates whether the trusted execution environment requests z-order enforcement for an overlay surface associated with the trusted execution environment; means for generating, by a processor of the computing device, wrapped programming information based on the display programming information in response to invoking the first processor instruction, wherein the wrapped programming information comprises a message authentication code over the z-order enforcement policy; means for invoking, by an untrusted supervisor component of the computing device, a second processor instruction with the wrapped programming information; and means for programming, by the processor, a display controller of the computing device with the z-order enforcement policy in response to invoking the second processor instruction.

Example 37 includes the subject matter of Example 36, and wherein to request z-order enforcement for the overlay surface comprises to request that the overlay surface associated with the trusted execution environment be composited in front of all other overlay surfaces.

Example 38 includes the subject matter of any of Examples 36 and 37, and further comprising means for enforcing, by the display controller, the z-order enforcement policy in response to programming the display controller.

Example 39 includes the subject matter of any of Examples 36-38, and wherein the means for enforcing the z-order enforcement policy comprises: means for determining whether a z-order enforcement bit associated with any overlay surface of the display controller is set; and means for composing an overlay surface with the associated z-order enforcement bit set in front of all other overlay surfaces of the display controller, wherein the overlay surface with the associated z-order enforcement bit set is the overlay surface associated with the trusted execution environment.

Example 40 includes the subject matter of any of Examples 36-39, and wherein: the means for invoking the first processor instruction comprises means for invoking an EBIND instruction; and the means for invoking the second processor instruction comprises means for invoking an UNWRAP instruction.

Example 41 includes the subject matter of any of Examples 36-40, and further comprising: means for determining, by the processor, whether the z-order enforcement policy indicates that the trusted execution environment requests z-order enforcement in response to invoking the second processor instruction; and means for determining, by the processor, whether an overlay surface of the display controller is available for z-order enforcement in response to determining that the z-order enforcement policy indicates that the trusted execution environment requests z-order enforcement; wherein the means for programming the display controller with the z-order enforcement policy comprises means for programming the display controller with the z-order enforcement policy in response to determining that the overlay surface is available.

Example 42 includes the subject matter of any of Examples 36-41, and wherein the means for determining whether the overlay surface of the display controller is available for z-order enforcement comprises means for reading a z-order enforcement status register of the display controller, wherein the z-order enforcement status register indicates whether any overlay surface of the display controller has a z-order enforcement bit set.

Example 43 includes the subject matter of any of Examples 36-42, and wherein the means for programming the display controller with the z-order enforcement policy comprises means for setting the z-order enforcement bit for the overlay surface associated with the trusted execution environment.

Example 44 includes the subject matter of any of Examples 36-43, and further comprising means for generating, by the processor, an authenticated response in response to determining that the overlay surface is not available, wherein the authenticated response indicates an error.

Example 45 includes the subject matter of any of Examples 36-44, and further comprising: means for verifying, by the processor, the message authentication code using a key wrapping key in response to invoking the second processor instruction, wherein the key wrapping key is a secret of the processor; wherein the means for generating the wrapped programming information comprises means for generating the message authentication code using the key wrapping key; and wherein the means for programming the display controller comprises means for programming the display controller in response to verifying the message authentication code.

Example 46 includes the subject matter of any of Examples 36-45, and further comprising: means for programming, by the processor, the display controller with a bitmap encryption key in response to invoking the second processor instruction, wherein the display programming information includes the bitmap encryption key; means for encrypting, by the trusted execution environment, graphics data with the bitmap encryption key to generate encrypted graphics data; and means for outputting, by the trusted execution environment, the encrypted graphics data to the overlay surface associated with the trusted execution environment in response to programming the display controller with the z-order enforcement policy.

Example 47 includes the subject matter of any of Examples 36-46, and further comprising: means for generating, by the processor, an authenticated response in response to programming the display controller, wherein the authenticated response indicates that the display controller was programmed successfully; means for receiving, by the trusted execution environment, the authenticated response from the untrusted supervisor component; means for determining, by the trusted execution environment, whether the authenticated response is authentic in response to receiving the authenticated response; and means for determining, by the trusted execution environment, whether the authenticated response indicates that the display controller was programmed successfully in response to determining that the authenticated response is authentic; wherein the means for outputting the encrypted graphics data to the overlay surface comprises means for outputting the encrypted graphics data to the overlay surface in response to determining that the authenticated response indicates that the display controller was programmed successfully.

Example 48 includes the subject matter of any of Examples 36-47, and further comprising means for requesting, by the untrusted supervisor component of the computing device, the display controller to use the overlay surface associated with the trusted execution environment.

Example 49 includes the subject matter of any of Examples 36-48, and further comprising: means for determining, by the untrusted supervisor component of the computing device, whether the z-order enforcement policy indicates that the trusted execution environment requests z-order enforcement; wherein the means for requesting the display controller to use the overlay surface comprises means for requesting the display controller to use a predetermined always-on-top overlay surface for the trusted execution environment in response to determining that the z-order enforcement policy indicates that the trusted execution environment requests z-order enforcement.

Example 50 includes the subject matter of any of Examples 36-49, and further comprising means for establishing, by the processor of the computing device, a secure enclave with secure enclave support of the processor, wherein the secure enclave comprises the trusted execution environment.

Example 51 includes the subject matter of any of Examples 36-50, and wherein the untrusted supervisor component comprises a kernel mode operating system component.

1. A computing device for secure display z-order enforcement, the computing device comprising:
a display controller;
a trusted execution environment to invoke a first processor instruction with display programming information that includes a z-order enforcement policy, wherein the z-order enforcement policy indicates whether the trusted execution environment requests z-order enforcement for an overlay surface associated with the trusted execution environment;
a processor that includes a wrapping engine to generate wrapped programming information based on the display programming information in response to invocation of the first processor instruction, wherein the wrapped programming information comprises a message authentication code over the z-order enforcement policy; and
an untrusted supervisor component to invoke a second processor instruction with the wrapped programming information;
wherein the processor further includes an unwrapping engine to program the display controller with the z-order enforcement policy in response to invocation of the second processor instruction.

2. The computing device of claim 1, wherein to request z-order enforcement for the overlay surface comprises to request that the overlay surface associated with the trusted execution environment be composited in front of all other overlay surfaces.

3. The computing device of claim 1, wherein the display controller further comprises a compositor to enforce the z-order enforcement policy in response to programming of the display controller.

4. The computing device of claim 3, wherein to enforce the z-order enforcement policy comprises to:
determine whether a z-order enforcement bit associated with any overlay surface of the display controller is set; and
compose an overlay surface with the associated z-order enforcement bit set in front of all other overlay surfaces of the display controller, wherein the overlay surface with the associated z-order enforcement bit set is the overlay surface associated with the trusted execution environment.

5. The computing device of claim 1, wherein:
the first processor instruction comprises an EBIND instruction; and
the second processor instruction comprises an UNWRAP instruction.

6. The computing device of claim 1, wherein:
the unwrapping engine is further to (i) determine whether the z-order enforcement policy indicates that the trusted execution environment requests z-order enforcement in response to the invocation of the second processor instruction, and (ii) determine whether an overlay surface of the display controller is available for z-order enforcement in response to a determination that the z-order enforcement policy indicates that the trusted execution environment requests z-order enforcement;
wherein to program the display controller with the z-order enforcement policy comprises to program the display controller with the z-order enforcement policy in response to a determination that the overlay surface is available.

7. The computing device of claim 6, wherein to determine whether the overlay surface of the display controller is available for z-order enforcement comprises to read a z-order enforcement status register of the display controller, wherein the z-order enforcement status register indicates whether any overlay surface of the display controller has a z-order enforcement bit set.

8. The computing device of claim 6, wherein the unwrapping engine is further to generate an authenticated response in response to a determination that the overlay surface is not available, wherein the authenticated response indicates an error.

9. The computing device of claim 1, wherein:
the unwrapping engine is further to program the display controller with a bitmap encryption key in response to the invocation of the second processor instruction, wherein the display programming information includes the bitmap encryption key; and
the trusted execution environment is further to (i) encrypt graphics data with the bitmap encryption key to generate encrypted graphics data, and (ii) output the encrypted graphics data to the overlay surface associated with the trusted execution environment in response to programming of the display controller with the z-order enforcement policy.

10. The computing device of claim 9, wherein:
the unwrapping engine is further to generate an authenticated response in response to the programming of the display controller, wherein the authenticated response indicates that the display controller was programmed successfully;
the trusted execution environment is further to (i) receive the authenticated response from the untrusted supervisor component, (ii) determine whether the authenticated response is authentic in response to receipt of the authenticated response, and (iii) determine whether the authenticated response indicates that the display controller was programmed successfully in response to a determination that the authenticated response is authentic; and
to output the encrypted graphics data to the overlay surface comprises to output the encrypted graphics data to the overlay surface in response to a determination that the authenticated response indicates that the display controller was programmed successfully.

11. The computing device of claim 1, wherein the processor further comprises secure enclave support to establish a secure enclave, wherein the secure enclave comprises the trusted execution environment.

12. A method for secure display z-order enforcement, the method comprising:
invoking, by a trusted execution environment of a computing device, a first processor instruction with display programming information that includes a z-order enforcement policy, wherein the z-order enforcement policy indicates whether the trusted execution environment requests z-order enforcement for an overlay surface associated with the trusted execution environment;
generating, by a processor of the computing device, wrapped programming information based on the display programming information in response to invoking the first processor instruction, wherein the wrapped programming information comprises a message authentication code over the z-order enforcement policy;
invoking, by an untrusted supervisor component of the computing device, a second processor instruction with the wrapped programming information; and
programming, by the processor, a display controller of the computing device with the z-order enforcement policy in response to invoking the second processor instruction.

13. The method of claim 12, wherein to request z-order enforcement for the overlay surface comprises to request that the overlay surface associated with the trusted execution environment be composited in front of all other overlay surfaces.

14. The method of claim 12, further comprising enforcing, by the display controller, the z-order enforcement policy in response to programming the display controller.

15. The method of claim 14, wherein enforcing the z-order enforcement policy comprises:
determining whether a z-order enforcement bit associated with any overlay surface of the display controller is set; and
composing an overlay surface with the associated z-order enforcement bit set in front of all other overlay surfaces of the display controller, wherein the overlay surface with the associated z-order enforcement bit set is the overlay surface associated with the trusted execution environment.

16. The method of claim 12, further comprising:
determining, by the processor, whether the z-order enforcement policy indicates that the trusted execution environment requests z-order enforcement in response to invoking the second processor instruction; and
determining, by the processor, whether an overlay surface of the display controller is available for z-order enforcement in response to determining that the z-order enforcement policy indicates that the trusted execution environment requests z-order enforcement;
wherein programming the display controller with the z-order enforcement policy comprises programming the display controller with the z-order enforcement policy in response to determining that the overlay surface is available.

17. The method of claim 16, wherein determining whether the overlay surface of the display controller is available for z-order enforcement comprises reading a z-order enforcement status register of the display controller, wherein the z-order enforcement status register indicates whether any overlay surface of the display controller has a z-order enforcement bit set.

18. The method of claim 16, further comprising generating, by the processor, an authenticated response in response to determining that the overlay surface is not available, wherein the authenticated response indicates an error.

19. One or more computer-readable storage media comprising a plurality of instructions stored thereon that, in response to being executed, cause a computing device to:
invoke, by a trusted execution environment of the computing device, a first processor instruction with display programming information that includes a z-order enforcement policy, wherein the z-order enforcement policy indicates whether the trusted execution environment requests z-order enforcement for an overlay surface associated with the trusted execution environment;
generate, by a processor of the computing device, wrapped programming information based on the display programming information in response to invoking the first processor instruction, wherein the wrapped programming information comprises a message authentication code over the z-order enforcement policy;
invoke, by an untrusted supervisor component of the computing device, a second processor instruction with the wrapped programming information; and
program, by the processor, a display controller of the computing device with the z-order enforcement policy in response to invoking the second processor instruction.

20. The one or more computer-readable storage media of claim 19, wherein to request z-order enforcement for the overlay surface comprises to request that the overlay surface associated with the trusted execution environment be composited in front of all other overlay surfaces.

21. The one or more computer-readable storage media of claim 19, further comprising a plurality of instructions stored thereon that, in response to being executed, cause the computing device to enforce, by the display controller, the z-order enforcement policy in response to programming the display controller.

22. The one or more computer-readable storage media of claim 21, wherein to enforce the z-order enforcement policy comprises to:
determine whether a z-order enforcement bit associated with any overlay surface of the display controller is set; and
compose an overlay surface with the associated z-order enforcement bit set in front of all other overlay surfaces of the display controller, wherein the overlay surface with the associated z-order enforcement bit set is the overlay surface associated with the trusted execution environment.

23. The one or more computer-readable storage media of claim 19, further comprising a plurality of instructions stored thereon that, in response to being executed, cause the computing device to:
determine, by the processor, whether the z-order enforcement policy indicates that the trusted execution environment requests z-order enforcement in response to invoking the second processor instruction; and
determine, by the processor, whether an overlay surface of the display controller is available for z-order enforcement in response to determining that the z-order enforcement policy indicates that the trusted execution environment requests z-order enforcement;
wherein to program the display controller with the z-order enforcement policy comprises to program the display controller with the z-order enforcement policy in response to determining that the overlay surface is available.

24. The one or more computer-readable storage media of claim 23, wherein to determine whether the overlay surface of the display controller is available for z-order enforcement comprises to read a z-order enforcement status register of the display controller, wherein the z-order enforcement status register indicates whether any overlay surface of the display controller has a z-order enforcement bit set.

25. The one or more computer-readable storage media of claim 23, further comprising a plurality of instructions stored thereon that, in response to being executed, cause the computing device to generate, by the processor, an authenticated response in response to determining that the overlay surface is not available, wherein the authenticated response indicates an error.
